(19) United States
(12) Patent Application Publication
(10) Pub. No.: US 2024/0425647 A1
(43) Pub. Date: Dec. 26, 2024

(54) POLYBENZOXAZOLE POWDER AND METHOD FOR PRODUCING THE SAME

(71) Applicant: TOYOBO MC Corporation, Osaka-shi, Osaka (JP)

(72) Inventors: Hiroki TSUSHIMA, Shiga (JP); Yuji IKEDA, Shiga (JP)

(21) Appl. No.: 18/683,019

(22) PCT Filed: Aug. 3, 2022
(86) PCT No.: PCT/JP2022/029747

§ 371 Date: Feb. 12, 2024

(30) Foreign Application Priority Data
Aug. 20, 2021 (JP) 2021-134717

(51) Int. Cl. C08G 73/22

(52) U.S. Cl. CPC C08G 73/22

(57) ABSTRACT

A polybenzoxazole powder having high dispersibility and excellent properties inherent in polybenzoxazole resin is obtained through an appropriate pre-treatment represented by heat treatment and subsequent mechanical pulverizing. The polybenzoxazole powder has an apparent density of 0.2 g/cm³ or more, a temperature at 5% weight loss of 550° C. or higher, and a specific surface area of 10 m²/g or more.

### TECHNICAL FIELD

The present invention relates to a polybenzoxazole powder having high dispersibility. The polybenzoxazole powder is well-suited as a raw material for a powder compact and a composite material (for example, a composite material with resin) each having high heat resistance.

### BACKGROUND ART

Conventionally, as high-performance resin powders, polyimide, polybenzimidazole, and poly(p-phenylene terephthalamide) have been used. These powders have high thermal properties, electrical properties, and mechanical properties. Due to such properties, the powders have been widely used as powder compacts and additives for resins. In recent years, there has been a growing demand for enhanced dimensional stability, heat conductivity, heat resistance, and insulation properties in the field of electronic devices, due to the trend toward higher performance and miniaturization.

In contrast, polybenzoxazole resin has been used as a fiber material in various applications due to its excellent mechanical properties, heat resistance, abrasion resistance, beat conductivity, and dimensional stability. For example, when polybenzoxazole fiber is used as an additive to resin, the polybenzoxazole fiber is processed into short fibers before use (Patent Document 1).

According to a known method, polybenzoxazole resin in powder (particle) form can be obtained by synthesizing precursor microparticles of polybenzoxazole from specific monomers and then converting the precursor microparticles into polybenzoxazole fine particles by a reaction (Non-Patent Document 1).

As a method for physically pulverizing high-strength fibers, pulverizing methods with a bead mill, a homogenizer, or a grinder, and other methods such as a counter collision method and a freeze pulverizing method are known (Patent Documents 2 and 3).

### CITATION LIST

### Patent Document

Patent Document 1: JP-A-H7-292533
Patent Document 2: JP-A-2008-150574
Patent Document 3: JP-B2-5186388

### Non-Patent Document

Non-Patent Document 1: H. Tachi, K. Asao, K. Yamamoto, and Y. Yoshioka, Proceedings of the 15th Japan Polyimide & Aromatic Polymers Study Group (2008), p. 79-81

### SUMMARY OF THE INVENTION

### Problems to be Solved by the Invention

However, in case where the short fibers of polybenzoxazole are added as an additive to resin as disclosed in Patent Document 1, there are limitations on the amount added and the dispersibility of the additive due to bulkiness and aggregation.

The method disclosed in Non-Patent Document 1 has not yet been commercially established, and the polybenzoxazole molecular structure, which can be synthesized with ring closure reaction in Non-Patent Document 1, leads to a problem of insufficient heat resistance.

In case where the polybenzoxazole fibers are made into powder by a conventional pulverizing method, for example, by a freeze pulverizing method as disclosed in Patent Document 3, the polybenzoxazole fibers are not sufficiently pulverized. Even if the polybenzoxazole fibers are pulverized with the conventional pulverizing method, fibrils are formed, resulting in aggregation of the powder. The aggregation of the powder causes a decrease in dispersibility in a composite material.

It is an object of the present invention to provide a polybenzoxazole powder having high dispersibility while maintaining excellent properties inherent in a polybenzoxazole resin.

### Solution to the Problems

As a result of diligent studies to solve above problems, the present inventors have found that a polybenzoxazole powder with excellent handling properties can be produced by subjecting polybenzoxazole to pre-treatment represented by heat treatment and subsequent mechanical pulverizing. This realization led to the completion of the present invention.

A polybenzoxazole powder of the present invention has an apparent density of 0.2 g/cm² or more, a temperature at 5% weight loss of 550° C. or higher, and a specific surface area of 10 m²/g or more.

The polybenzoxazole powder of the present invention shows a breakdown voltage of 5 kV/mm or more in the form of a compact produced by pressing and molding 1000 g of the polybenzoxazole powder per 1 m² at 200° C. and at a pressure of 40 MPa.

In a method for producing the polybenzoxazole powder of the present invention, the polybenzoxazole powder is produced from a polybenzoxazole fiber.

A polybenzoxazole powder compact of the present invention comprises the polybenzoxazole powder.

A composite material of the present invention comprises the polybenzoxazole powder.

### Advantageous Effects of the Invention

According to the present invention, the polybenzoxazole powder can be provided with high heat resistance (preferably heat resistance and electrical properties), which is the characteristic inherent in the polybenzoxazole resin. In the polybenzoxazole powder of the present invention, aggregation is prevented; therefore, the powder has high dispersibility to a binder such as resin, enabling production of uniform composite material.

### DESCRIPTION OF EMBODIMENTS

Hereinafter, the present invention will be described in detail.

### [Polybenzoxazole]

The polybenzoxazole of the present invention broadly includes polymers having a unit in which one or more oxazole rings are combined to an aromatic ring by condensation. The polybenzoxazole may include one or more types of polymers. The aromatic ring is preferably a hydrocarbon ring such as a benzene ring, a biphenylene ring, and a naphthalene ring, and more preferably a benzene ring. The polybenzoxazole is preferably a polymer having a unit in which one or two (preferably two) oxazole rings are condensed to a benzene ring. In the hydrocarbon ring, one or more hydrogen atoms may optionally be replaced with substituents. Examples of the substituent include alkyl groups such as a methyl group, an ethyl group, a propyl group, and a butyl group (preferably C₁₋₄ alkyl group); and halogen atoms such as a fluorine atom, a chlorine atom, a bromine atom, and an iodine atom.

In addition to the unit described above, the polybenzoxazole of the present invention may further have an aromatic ring unit Examples of the aromatic ring unit include aromatic hydrocarbon ring units such as a phenylene group, a biphenylene group, and a naphthylene group; and aromatic heterocyclic units such as a pyridylene group. Among them, an aromatic hydrocarbon ring unit is preferred, and a phenylene group is more preferred. In the aromatic ring unit, one or more hydrogen atoms may optionally be replaced with substituents. Examples of the substituent include alkyl groups such as a methyl group, an ethyl group, a propyl group, and a butyl group (preferably C₁₋₄ alkyl group); and halogen atoms such as a fluorine atom, a chlorine atom, a bromine atom, and an iodine atom.

The polybenzoxazole of the present invention is preferably a polymer specifically having at least one structural unit selected from the following Chemical Formulae (a) to (d), more preferably a polymer containing at least one structural unit selected from the following Chemical Formulae (a) to (d) as a main component. The description “containing as a main component” indicates that the polybenzoxazole contains the structural unit in an amount of, for example, 50% by mass or more, preferably 70% by mass or more, more preferably 80% by mass or more, and further preferably 90% by mass or more.

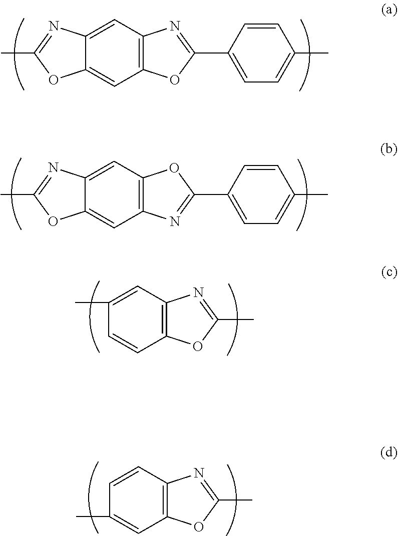

The polybenzoxazole of the present invention is preferably poly(p-phenylenebenzobisoxazole); a copolymer in which one or more hydrogen atoms of the poly(p-phenylenebenzobisoxazole) are replaced with C₁₋₄ alkyl groups or halogen atoms; a copolymer A in which one or more phenylene groups of the poly(p-phenylenebenzobisoxazole) are replaced with heterorings such as a pyridine ring, or a copolymer in which one or more hydrogen atoms in the copolymer A are replaced with C₁₋₄ alkyl groups or halogen atoms. The polybenzoxazole of the present invention is more preferably poly(p-phenylenebenzobisoxazole).

### [Method for Producing Polybenzoxazole]

Prior to powdering, the polybenzoxazole of the present invention is produced by a conventionally known method. For example, before powdering, the polybenzoxazole is produced through polymerization in a non-oxidizing sol vent capable of dissolving cresols and synthesized polymer (i.e., polybenzoxazole).

### [Method for Producing Poly Benzoxazole Powder]

The polybenzoxazole for pulverizing process is preferably processed into a fibrous form. Processing into a fibrous form enables easy removal of a solvent contained in the polybenzoxazole, resulting in increased productivity.

A method for processing the polybenzoxazole into a fibrous form is not particularly limited, and a known method can be employed. For example, in one method, the polybenzoxazole is dissolved in a non-oxidizing solvent and then discharged from a spinneret into a fibrous form. As the polybenzoxazole in a fibrous form, commercially available products such as Zylon (manufactured by TOYOBO CO., LTD.) may be used.

The molecular weight of the polybenzoxazole forming the polybenzoxazole fiber can be showed by the limiting viscosity. The polybenzoxazole has a limiting viscosity of preferably from 25 dL/g to 50 dL/g when measured at 25° C. with a methanesulfonic acid solvent.

The polybenzoxazole fiber for pulverizing process has a fiber diameter (the diameter of a single filament) of preferably from 1 μm to 100 μm and more preferably from 5 μm to 50 μm. A fiber diameter of 1 μm or less may result in low fiber productivity. A fiber diameter of more than 100 μm may cause insufficient removal of a solvent.

In case where the polybenzoxazole fiber is pulverized, the polybenzoxazole fiber is preferably processed into short fibers prior to pulverizing to enhance processability. The length of the short fiber is not particularly limited. The length of the short fiber is preferably from 0.1 mm to 50 mm and more preferably from 1 mm to 10 mm. Too long length of the short fiber causes unevenness of particles after pulverizing, whereas too short length of the short fiber is not commercially suitable due to the high processing costs associated with the production of short fibers.

The polybenzoxazole for pulverizing is preferably subjected to pre-treatment in order to conduct the pulverizing process efficiently. In the pre-treatment, polybenzoxazole molecule is preferably cut at a certain amount that does not cause significant decrease in the temperature at weight loss. Hereinafter, this pre-treatment is sometimes referred to as “treatment prior to pulverizing”. This treatment can facilitate pulverizing of polybenzoxazole even with high mechanical properties and reduce fibril formation, thereby preventing the resulting powder from aggregation. Therefore, the resulting powder can have improved dispersibility to a binder such as resin. The powder also has high moldability, and a powder compact with a pleasant texture can be produced from the powder.

The treatment prior to pulverizing is not particularly limited, and a known method can be employed. Specific examples of the treatment prior to pulverizing include heat treatments such as a heat treatment in an air atmosphere, a heat treatment in an inert gas atmosphere, a vacuum heat treatment, and a steam treatment, each conducted in a tension-free state. The treatment prior to pulverizing is preferably a heat treatment in an air atmosphere or a heat treatment in an inert gas atmosphere. Heat treatment in an air atmosphere is preferably employed because this treatment makes it easier to maintain excellent mechanical properties of the polybenzoxazole.

A temperature for heat treatment in an air atmosphere is preferably from 200° C. to 600° C., more preferably from 250° C. to 600° C., and further preferably from 300° C. to 600° C. A temperature lower than 200° C. may require a long treatment time. A temperature higher than 600° C. may cause decomposition of the polybenzoxazole to such an extent that the polybenzoxazole cannot maintain its performance.

Treatment time for heat treatment in an air atmosphere can be appropriately adjusted depending on the treatment temperature and is not particularly limited. The treatment time is, for example, from 1 hour to 100 hours, preferably from 20 hours to 80 hours, and more preferably from 25 hours to 60 hours.

The heat treatment in an inert gas atmosphere is a heat treatment process conducted in an inert gas atmosphere. The inert gas is exemplified by nitrogen, carbon dioxide, helium, and argon, and nitrogen is preferred due to ease of acquisition.

A temperature for the heat treatment in an inert gas atmosphere is preferably from 300° C. to 650° C., more preferably from 400° C. to 600° C., and further preferably from 500° C. to 600° C. A temperature lower than 300° C. may require long treatment time. A temperature higher than 650° C. may cause decomposition of the polybenzoxazole to such an extent that the polybenzoxazole cannot maintain its performance.

Treatment time for the heat treatment in an inert gas atmosphere can be appropriately adjusted depending on the treatment temperature and is not particularly limited. The treatment time is, for example, from 5 minutes to 20 hours, preferably from 10 minutes to 15 hours, and more preferably from 30 minutes to 10 hours.

A temperature for the vacuum heat treatment is preferably from 200° C.′ to 600° C., more preferably from 250° C. to 600° C., and further preferably from 300° C. to 600° C. A temperature lower than 200° C. may require long treatment time. A temperature higher than 600° C. may cause decomposition of the polybenzoxazole to such an extent that the polybenzoxazole cannot maintain its performance.

Treatment time for the vacuum heat treatment can be appropriately adjusted depending on the treatment temperature and is not particularly limited. The treatment time is, for example, from 5 minutes to 20 hours, preferably from 10 minutes to 15 hours, and more preferably from 30 minutes to 10 hours.

The steam treatment is conducted preferably with heating steam. The steam temperature is preferably from 150° C. to 600° C. more preferably from 200° C. to 600° C., and further preferably from 250° C. to 600° C. A steam temperature lower than 150° C. may require long treatment time and a steam temperature higher than 600° C. may cause decomposition of the polybenzoxazole to such an extent that the polybenzoxazole cannot maintain its performance.

The heat treatment may be applied to the polybenzoxazole not processed into a fibrous form; however, the heat treatment is preferably applied to the polybenzoxazole processed into a short fiber having a fiber length of from 0.1 mm to 50 mm.

The treatment prior to pulverizing is preferably conducted in a tension-free state. “Treatment in a tension-free state” indicates that the treatment is conducted under the conditions where no tension is actively applied (preferably under conditions without stretching). The treatment prior to pulverizing is preferably conducted under a tension of, for example, less than 0.3 gf/dtex, and preferably 0.1 gf/dtex or less.

With respect to the molecular weight of the polybenzoxazole after the treatment prior to pulverizing, the polybenzoxazole after the treatment prior to pulverizing has a limiting viscosity of preferably from 5 dL/g to 25 dL/g, and more preferably from 10 dL/g to 23 dL/g. The limiting viscosity equal to or greater than the predetermined value can lead to improvement in mechanical properties and thermal properties of the polybenzoxazole after pulverizing. The limiting viscosity equal to or lower than the predetermined value can lead to a reduction in the energy required for pulverizing, allowing easier pulverizing of the polybenzoxazole. The limiting viscosity is a value measured at 25° C. with a methanesulfonic acid solvent.

A method for mechanically pulverizing the polybenzoxazole fiber is not particularly limited. Examples of the method include a method with a bead mill, a method with a homogenizer, a counter collision method a method with a grinder, a freeze pulverizing method, and a roll-press method. In pulverizing, these methods may be employed individually, or as a combination of two or more methods. As a method for pulverizing, a freeze pulverizing method or a roll-press method is preferable.

### [Properties of Poly Benzoxazole Powder]

The polybenzoxazole powder of the present invention has an apparent density of 0.20 g/cm³ or more and preferably 0.25 g/cm³ or more. The apparent density within the range is preferred because such an apparent density leads to a decrease in aggregation of the polybenzoxazole powder and thus increases in dispersibility and moldability. The upper limit of the apparent density is not particularly limited and is preferably 1.0 g/cm³ or less from the viewpoint of the energy required for pulverizing.

The polybenzoxazole powder has a specific surface area of 10 m²/g or more, preferably 15 m²/g or more and more preferably 30 m²/g or more. The specific surface area within the range leads to a decrease in aggregation of the polybenzoxazole powder, resulting in increase in dispersibility and moldability. The upper limit of the specific surface area is not particularly limited and is preferably 100 m²/g or less from the view point of the energy required for pulverizing.

The polybenzoxazole powder of the present invention maintains high heat resistance inherent in the polybenzoxazole resin. Specifically, the polybenzoxazole powder has a temperature at 5% weight loss of 550° C. or higher, preferably 575° C. or higher, and more preferably 600° C. or higher. The temperature at 5% weight loss within the range allows the use in applications requiring high heat resistance. The upper limit of the temperature at 5% weight loss is not particularly limited. The temperature is preferably 650° C. or lower to prevent a decrease in electrical properties due to carbonization.

The polybenzoxazole powder of the present invention is sufficiently pulverized, allowing the powder in the form of a compact to have a desirable breakdown voltage. The polybenzoxazole powder shows a breakdown voltage of preferably 5 kV/mm or more, more preferably 6 kV/mm or more, and particularly preferably 10 kV/mm or more in the form of a compact produced by pressing and molding 1000 g of the polybenzoxazole powder per 1 m² at 200° C. and at a pressure of 40 MPa. When the breakdown voltage is within the range, the polybenzoxazole powder can withstand the use in fields requiring insulating properties. The upper limit of the breakdown voltage is not particularly limited and is preferably 40 kV/mm or less due to processing limitations of pulverizing treatment. The breakdown voltage can be measured in accordance with the method specified by JIS C 2110.

The polybenzoxazole powder of the present invention has a limiting viscosity of preferably from 5 dL/g to 25 dL/g and more preferably from 10 dL/g to 23 dL/g. The limiting viscosity is a value measured at 25° C. with a methanesulfonic acid solvent

### [Composite Material]

The polybenzoxazole powder of the present invention can be used as an additive to produce a composite material with organic materials such as resin and rubber or inorganic materials such as metal, ceramic, and cement. The composite material preferably comprises the polybenzoxazole powder and at least one material selected from the group consisting of resin, rubber, metal, ceramic and cement. More preferably, the composite material comprises the polybenzoxazole powder and resin.

Examples of the resin include an epoxy resin, a polyimide resin a polyphenylene ether resin, and a fluororesin.

Examples of the rubber include natural rubber, isoprene rubber, styrene rubber, butadiene rubber, chloroprene rubber, butyl rubber, nitrile rubber, ethylene propylene rubber, acrylic rubber, urethane rubber, and fluororubber.

Examples of the metal include carbon steel, tool steel, stainless steel, an aluminum alloy, a titanium alloy, a nickel alloy, and a cobalt alloy.

Examples of the ceramic include alumina, zirconia, mullite, ferrite magnet, aluminum nitride, and silicon carbide.

These components may be used alone or in combination of two or more.

The amount of the polybenzoxazole powder in the composite material is not particularly limited. The amount is, for example, from 2% by mass to 90% by mass, preferably from 10% by mass to 80% by mass, and more preferably from 20% by mass to 70% by mass.

The composite material can be applied for, for example, wear-resistant plastic components, heat-resistant plastic components, and sliding friction materials such as disc brake pads.

### [Polybenzoxazole Powder Compact]

The polybenzoxazole powder of the present invention can be molded into a powder compact. The polybenzoxazole powder of the present invention has high moldability and the resulting polybenzoxazole powder compact can have a pleasant texture. The polybenzoxazole powder of the present invention alone may be formed into the powder compact by, for example, thermal molding, or the polybenzoxazole powder along with a binder may be formed into the powder compact.

The powder compact of the present invention can be produced by a common method such as a compression molding method. In the compression molding method, the polybenzoxazole powder and, if needed, an additive such as a binder are poured in a mold and are sintered under pressure.

The pressure for compression molding is, for example, from 1 MPa to 150 MPa and preferably from 10 MPa to 100 MPa. The temperature for compression molding is, for example, from 100° C. to 500° C., and preferably from 200° C. to 400° C. The pressing time is not particularly limited, and is, for example, from 5 minutes to 10 hours.

As described above, the powder compact (preferably the powder compact produced by the compression molding method) may contain a binder. The binder may be organic materials such as resin and rubber or inorganic materials such as a ceramic. The resin and the rubber as binders may be the same as the resin and the rubber available for a composite material, and resin is preferable. These binders may be used alone or in combination of two or more.

The content of the polybenzoxazole powder in the powder compact is not particularly limited. The content is, for example, 10% by mass or more, preferably 20% by mass or more and more preferably 40% by mass or more. The content may be 100% by mass, 98% by mass or less, or 90% by mass or less. The content of the polybenzoxazole powder in the powder compact is preferably from 10% by mass to 100% by mass, more preferably from 20% by mass to 98% by mass, and further preferably from 40% by mass to 90% by mass.

The content of the binder in the powder compact is not particularly limited, and the content is, for example, from 2% by mass to 60% by mass, and preferably from 10% by mass to 55% by mass.

The powder compact can be applied for, for example, bearings, seals, wafer guides, gear wheels, and valves.

The polybenzoxazole powder of the present invention maintains excellent properties inherent in polybenzoxazole (mechanical properties, heat resistance, abrasion resistance, thermal conductivity, dimensional stability, and electrical properties), therefore, the composite material and the powder compact have excellent properties (at least one characteristic selected from mechanical properties, heat resistance, abrasion resistance, thermal conductivity, dimensional stability, and electrical properties, preferably at least one characteristic selected from heat resistance, electrical properties, and dimensional stability, and more preferably heat resistance and electrical properties).

The present application claims benefit of priority to Japanese Patent Application No. 2021-134717 filed on Aug. 20, 2021. The entire contents of the specification of Japanese Patent Application No 2021-134717 filed on Aug. 20, 2021, are incorporated herein by reference.

### EXAMPLES

Hereinafter, the present invention will be more specifically described with Examples and Comparative Examples. However, the scope of the present invention is not limited by Examples.

The followings are methods employed for evaluating physical characteristics in Examples.

### (1) Apparent Density

Measurement was conducted in accordance with JIS K 7365. A sample of polybenzoxazole powder was poured into a glass container to the top edge. The excess powder over the top edge was removed with a plate for leveling the powder at the height of the top edge. Subsequently, the remaining powder was weighed. An apparent density was calculated based on the ratio of the obtained sample weight to the container volume.

### (2) Temperature at 5% Weight Loss

A temperature at 5% weight loss was measured by heating 10 mg of polybenzoxazole powder from 30° C. to 1000° C. at a heating rate of 20° C./min under an air atmosphere using a thermogravimetric analyzer (model: TGA-Q50, manufactured by TA Instruments).

To eliminate the influence of moisture, the weight at 150° C. was regarded as 100%. The temperature at which the weight decreased to 95% was determined as a temperature at 5% weight loss.

### (3) Specific Surface Area

To measure a specific surface area, 1 g of polybenzoxazole powder was weighed out and treated at 120° C. for 12 hours under vacuum in advance. Subsequently, the treated sample underwent measurement with a specific surface area measuring device (model: GEMINI VII, manufactured by Shimadzu Corporation) to determine the specific surface area calculated based on a BET method from the amount of nitrogen adsorbed.

### (4) Breakdown Voltage

In a metal mold with a bottom area of 20 cm², 2 g of polybenzoxazole powder was poured, and the powder was press-molded at 200° C. with a pressure of 40 MPa for 30 minutes. The resulting polybenzoxazole powder in the form of a compact was tested in accordance with conditions specified in JIS C 2110. The compact was sandwiched between a spherical electrode (Φ: 20 mm) and a disk electrode (Φ: 25 mm) in the air. The voltage was applied to the compact and increased at a rate of 500 V/s in an atmosphere at 23° C. and at 50% RH to induce breakdown. The breakdown voltage (kV/mm) was determined from the voltage at which the breakdown was induced and the thickness of the compact.

### (5) Limiting Viscosity

A polymer solution having a concentration of 0.5 g/l was prepared with a methanesulfonic acid solution. A limiting viscosity was determined by measuring the viscosity of the polymer solution with an Ostwald viscometer in a thermostatic bath set at 25° C.

### Example 1

The polybenzoxazole fibers (product name: Zylon, manufactured by TOYOBO CO., LTD.) cut into 1 mm were prepared as a raw material and heat treated at 350° C. for 48 hours in an air atmosphere.

The heat-treated polybenzoxazole fibers were pulverized with a cryogenic sample crusher (model: JFC-2000, manufactured by Japan Analytical Industry Co., Ltd.) for 30 minutes at a speed of 50 Hz.

The resulting powder had an apparent density of 0.26 g/cm³, a temperature at 5% weight loss of 609° C. and a specific surface area of 41.8 m²/g. No aggregates were observed in the powder. The powder in the form of a compact had a breakdown voltage of 14.3 kV/mm.

### Example 2

The polybenzoxazole fibers (product name: Zylon, manufactured by TOYOBO CO., LTD.) cut into 1 mm were prepared as a raw material and heat treated at 400° C. for 40 hours in an air atmosphere.

The heat-treated polybenzoxazole fibers were pulverized with a cryogenic sample crusher (model: JFC-2000, manufactured by Japan Analytical Industry Co., Ltd.) for 30 minutes at a speed of 50 Hz.

The resulting powder had an apparent density of 0.25 g/cm³, a temperature at 5% weight loss of 609° C., and a specific surface area of 32.8 m²/g. No aggregates were observed in the powder. The powder in the form of a compact had a breakdown voltage of 13.4 kV/mm.

### Example 3

The polybenzoxazole fibers (product name: Zylon, manufactured by TOYOBO CO., LTD.) cut into 1 mm were prepared as a raw material and heat treated at 600° C. for 1 hour in a nitrogen atmosphere.

The heat-treated polybenzoxazole fibers were pulverized with a cryogenic sample crusher (model: JFC-2000, manufactured by Japan Analytical Industry Co., Ltd.) for 30 minutes at a speed of 50 Hz.

The resulting powder had an apparent density of 0.21 g/cm³, a temperature at 5% weight loss of 609° C., and a specific surface area of 18.9 m²/g. No aggregates were observed in the powder. The powder in the form of a compact had a breakdown voltage of 6.2 kV/mm.

### Example 4

The polybenzoxazole fibers (product name: Zylon, manufactured by TOYOBO CO., LTD.) cut into 1 mm were prepared as a raw material and heat treated at 550° C. for 1.5 hours in a nitrogen atmosphere.

The heat-treated polybenzoxazole fibers were pulverized with a cryogenic sample crusher (model: JFC-2000, manufactured by Japan Analytical Industry Co., Ltd.) for 30 minutes at a speed of 50 Hz.

The resulting powder had an apparent density of 0.22 g/cm³, a temperature at 5% weight loss of 610° C. and a specific surface area of 16.8 m²/g. No aggregates were observed in the powder. The powder in the form of a compact had a breakdown voltage of 6.0 kV/mm.

### Comparative Example 1

The polybenzoxazole fibers (product name: Zylon, manufactured by TOYOBO CO., LTD.) cut into 1 mm were prepared as a raw material.

The polybenzoxazole fibers were pulverized with a cryogenic sample crusher (model: JFC-2000, manufactured by Japan Analytical Industry Co., Ltd.) for 30 minutes at a speed of 50 Hz.

The resulting powder had an apparent density of 0.16 g/cm³, a temperature at 5% weight loss of 621° C., and a specific surface area of 0.8 m²/g. Aggregates were observed in the powder. The powder in the form of a compact had a breakdown voltage of 4.8 kV/mm.

TABLE 1

| | | | | | Comparative |
|---|---|---|---|---|---|
| | Example 1 | Example 2 | Example 3 | Example 4 | Example 1 |
| Apparent density of | 0.26 | 0.25 | 0.21 | 0.22 | 0.16 |
| polybenzoxazole | | | | | |
| powder [g/cm³] | | | | | |
| Temperature at 5% weight | 609 | 609 | 609 | 610 | 621 |
| loss of polybenzoxazole | | | | | |
| powder [° C.] | | | | | |
| Specific surface area | 41.8 | 32.8 | 18.9 | 16.8 | 0.8 |
| of polybenzoxazole | | | | | |
| powder [m²/g] | | | | | |
| Breakdown voltage | 14.3 | 13.4 | 6.2 | 6.0 | 4.8 |
| of polybenzoxazole | | | | | |
| powder [kV/mm] | | | | | |
| Limiting viscosity of | 18.5 | 19.0 | 5.7 | 5.8 | 27.0 |
| polybenzoxazole | | | | | |
| powder [dL/g] | | | | | |
| Aggregates of | Not observed | Not observed | Not observed | Not observed | Observed |
| polybenzoxazole powder | | | | | |

The polybenzoxazole powder produced in Examples each had increased apparent density and specific surface area while excellent characteristics inherent in polybenzoxazole were maintained, leading to reduced aggregation of the powder. Accordingly, the polybenzoxazole powder can be well kneaded with a binder of, for example, a resin, enabling production of uniform composite material.

### INDUSTRIAL APPLICABILITY

According to the present invention, polybenzoxazole powder having high moldability and dispersibility can be provided while excellent heat resistance and electrical properties inherent in polybenzoxazole resin are maintained, leading to applicability in various fields.

1. A polybenzoxazole powder having an apparent density of 0.2 g/cm³ or more, a temperature at 5% weight loss of 550° C. or higher, and a specific surface area of 10 m²/g or more.

2. The polybenzoxazole powder according to claim 1, wherein the polybenzoxazole powder shows a breakdown voltage of 5 kV/mm or more in the form of a compact produced by pressing and molding 1000 g of the polybenzoxazole powder per 1 m² at 200° C. and at a pressure of 40 MPa.

3. A method for producing polybenzoxazole powder according to claim 1, wherein the polybenzoxazole powder is produced from a polybenzoxazole fiber.

4. A polybenzoxazole powder compact comprising the polybenzoxazole powder according to claim 1.

5. A composite material comprising the polybenzoxazole powder according to claim 1.
